(19) United States
(12) Patent Application Publication
(10) Pub. No.: US 2021/0095818 A1
(43) Pub. Date: Apr. 1, 2021

(54) RESTRAINING STRUCTURE FOR STRUCTURAL OBJECT

(71) Applicant: TOYOTA JIDOSHA KABUSHIKI KAISHA, Aichi-ken (JP)

(72) Inventor: Osamu SAWAI, Okazaki-shi (JP)

(21) Appl. No.: 16/984,055

(22) Filed: Aug. 3, 2020

(30) Foreign Application Priority Data
Sep. 27, 2019 (JP) 2019-177639

(51) Int. Cl. F17C 1/02; F16B 2/08; B65D 63/10; D07B 1/22; D07B 1/02

(52) U.S. Cl. CPC F17C 1/02; F16B 2/08; B65D 63/10; D07B 1/22; D07B 1/02; F17C 2270/0184; D07B 2205/3007; F17C 2203/0604; F17C 2203/0646; F17C 2203/0675; F17C 2205/0305; F17C 2203/012; F17C 2203/0624; F17C 2221/012

(57) ABSTRACT

A restraining structure for a structural body includes: a restrained portion that is a tubular body or a stacked body; a pair of holding portions provided at the restrained portion; a first CFRP belt wrapped around the restrained portion in an axial direction of the restrained portion so as to extend between the pair of holding portions and having carbon fibers of a 0° direction along the axial direction; and a second CFRP belt stacked adjacent to an outermost layer near an end of the first CFRP belt and having carbon fibers of 45° to 90° directions with respect to the axial direction. One of the holding portions is provided at an end of the restrained portion. The other of the holding portions is provided at the other end of the restrained portion.

### INCORPORATION BY REFERENCE

The disclosure of Japanese Patent Application No. 2019-177639 filed on Sep. 27, 2019 including the specification, drawings and abstract is incorporated herein by reference in its entirety.

### BACKGROUND

### 1. Technical Field

The disclosure relates to restraining structures for a structural object including a tubular body or a stacked body.

### 2. Description of Related Art

Japanese Unexamined Patent Application Publication No. 2018-119578 (JP 2018-119578 A) discloses a restraining structure for a high-pressure tank. In this restraining structure, a sheet-like carbon fiber reinforced plastic (CFRP) belt is wrapped a body portion of the high-pressure tank in the axial direction of the body portion. Such a restraining structure is also applicable to restraining a battery composed of a plurality of cells.

### SUMMARY

However, in such a restraining structure, when tension applied to the CFRP belt increases due to expansion of the structural body etc., a shear stress is intensively applied between layers of the CFRP belt at the wrapping end of the CFRP belt, and the layers of the CFRP belt may be separated from each other.

The disclosure provides a restraining structure for a structural body which is capable of reducing a shear stress at the wrapping end of a CFRP belt and thus capable of suppressing the separation of layers of the CFRP belt from each other.

A first aspect of the disclosure is a restraining structure for a structural body. The restraining structure includes: a restrained portion that is a tubular body or a stacked body; a pair of holding portions provided at the restrained portion; a first CFRP belt wrapped around the restrained portion in an axial direction of the restrained portion so as to extend between the pair of holding portions and having carbon fibers of a 0° direction along the axial direction; and a second CFRP belt stacked adjacent to an outermost layer near an end of the first CFRP belt and having carbon fibers of 45° to 90° directions with respect to the axial direction. One of the holding portions is provided at an end of the restrained portion. The other of the holding portions is provided at the other end of the restrained portion.

In the first aspect, the restrained portion that is a tubular body or a stacked body is held from its both sides by the pair of holding portions, and the first CFRP belt is wrapped around the restrained portion so as to extend between the pair of holding portions in the axial direction of the restrained portion. The first CFRP belt has, in the axial direction of the restrained portion, the carbon fibers in the 0° direction along the axial direction. In the case where the restrained portion is a tubular body, the axial direction is a direction along a central axis of the tubular body. In the case where the restrained portion is a stacked body, the axial direction is a direction along a stacking direction. The 0° direction along the axial direction includes an error in the direction of the carbon fibers which occurs when manufacturing the first CFRP belt and an error in the direction of the carbon fibers which occurs when the first CFRP belt is wrapped around the restrained portion. The second CFRP belt having the carbon fibers in the 45° to 90° directions is stacked adjacent to the outermost layer near the end of the first CFRP belt. The range of numerical values described using “to” includes the numerical values before and after “to” as the upper and lower limit values of the range.

When a stress is generated in a section of the CFRP belt having the carbon fibers, the performance of the carbon fibers greatly contributes against a force in the 0° direction and the performance of resin greatly contributes against a force in the 90° direction. That is, according to the first aspect, the second CFRP belt having the carbon fibers in a direction crossing the direction of tension provides elasticity in the axial direction. Accordingly, even when a shear stress is intensively applied to the wrapping end of the first CFRP belt, this shear stress is reduced by the elasticity of the second CFRP belt. The separation of layers of the belts from each other is therefore suppressed.

In the restraining structure for the structural body according to the first aspect, the end of the first CFRP belt may be disposed near a connection portion between a curved portion of the first CFRP belt and a straight portion of the first CFRP belt that extends along the restrained portion.

According to the above configuration, both a bending stress and a tensile stress are applied to the connection portion between the curved portion and the straight portion of the first CFRP belt, namely the R end (the end of the curve). The bending stress that is applied to the end of the curve is a stress that acts outward in the axial direction on the upper layer side of the first CFRP belt and that acts inward in the axial direction on the lower layer side of the first CFRP belt. Accordingly, in the resultant force of the bending stress and the tensile stress acting inward in the axial direction, the tensile stress is cancelled by the bending stress on the upper layer side of the first CFRP belt. According to the above configuration, wrapping of the first CFRP belt is ended at the connection portion between the curved portion and the straight portion of the first CFRP belt such that the tensile stress is reduced as closer to the top layer of the first CFRP belt. The shear stress that is applied to the wrapping end of the first CFRP belt is therefore further reduced, and the separation of the layers of the belts from each other is suppressed.

In the first aspect, the restraining structure may include a third CFRP belt having the carbon fibers of the 45° to 90° directions with respect to the axial direction. The third CFRP belt may be stackable between the layers of the first CFRP belt wrapped around the restrained portion and the pair of holding portions, and a proportion of the carbon fibers of the 45° to 90° directions in all stacked belts may be 10% or more and 50% or less.

The proportion of the carbon fibers of the 45° to 90° directions in all the stacked CFRP belts may be 10% or more and 50% or less. According to the above configuration, the second CFRP belt having the carbon fibers in a direction crossing the direction of tension provides elasticity in a thickness direction. This configuration reduces a surface pressure applied in the thickness direction to the curved portion of the first CFRP belt having the carbon fibers in the 0° direction, namely the portion where the first CFRP belt is bent, and suppresses occurrence of a compression failure.

According to the first aspect of the disclosure, the shear stress that is applied to the wrapping end of the CFRP belt is reduced, and the separation of the layers of the belts from each other is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a tank module composed of a combination of high-pressure tanks according to a first embodiment;

FIG. 2 is a side sectional view of the high-pressure tank according to the first embodiment;

FIG. 3 is a side sectional view (enlarged view of FIG. 2) of a portion near a boss of the high-pressure tank according to the first embodiment;

FIG. 4 is a side view of the portion near the boss of the high-pressure tank according to the first embodiment, schematically illustrating a resultant force that is applied to an end of a curve;

FIG. 5 is a partial enlarged side sectional view of a fixing belt of the high-pressure tank according to the first embodiment;

FIG. 6 is a plan view of the fixing belt of the high-pressure tank according to the first embodiment, schematically illustrating the directions of carbon fibers; and

FIG. 7 is a perspective view of a battery module composed of a combination of battery units according to a second embodiment.

### DETAILED DESCRIPTION OF EMBODIMENTS

### First Embodiment

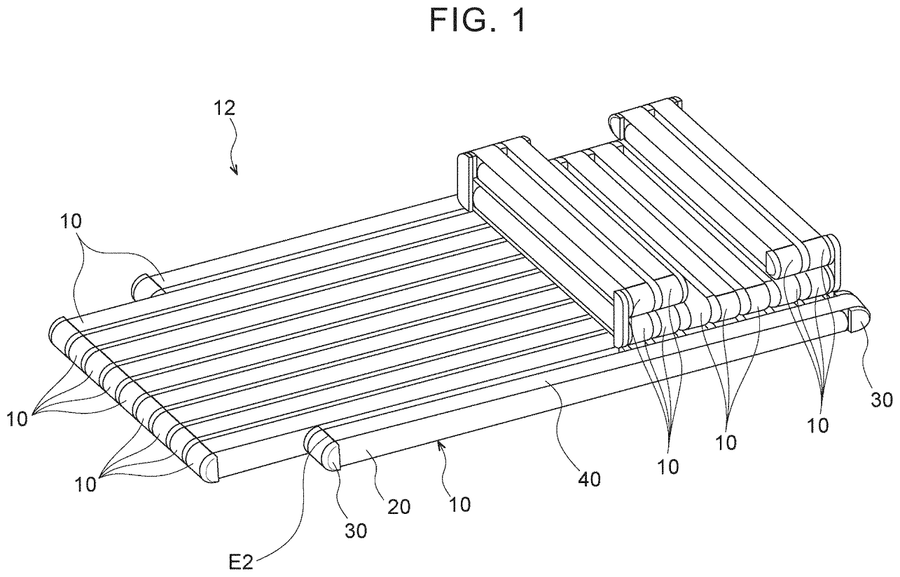

A high-pressure tank 10 of a first embodiment to which a restraining structure for a structural object has been applied will be described with reference to FIGS. 1 to 6.

As shown in FIG. 1, a high-pressure tank 10, which is a structural object, constitutes a part of a tank module 12. That is, the tank module 12 is configured by arranging and connecting a plurality of high-pressure tanks 10. For example, the tank module 12 is accommodated under a floor panel of a fuel cell vehicle. The high-pressure tank 10 of the present embodiment contains, for example, hydrogen that is a fluid.

The high-pressure tank 10 has a cylindrical shape of which axial direction (longitudinal direction) is the longitudinal direction of the vehicle. The high-pressure tank 10 includes a tubular body portion 20, a pair of bosses 30, and a fixing belt 40. The bosses 30 are provided at respective axial ends of the body portion 20, and the fixing belt 40 is wrapped around the body portion 20 along the axial direction of the body portion 20 so as to extend between the bosses 30. The body portion 20 is an example of a restrained portion that is the tubular body, and the bosses 30 are an example of holding portions. Hereinafter, the axial direction of the body portion 20 is simply referred to as the axial direction and the radial direction of the body portion 20 is simply referred to as the radial direction unless otherwise specified.

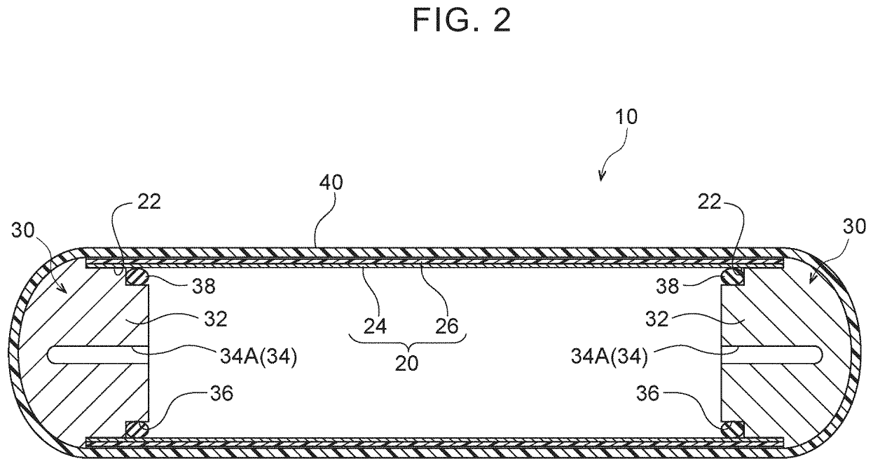

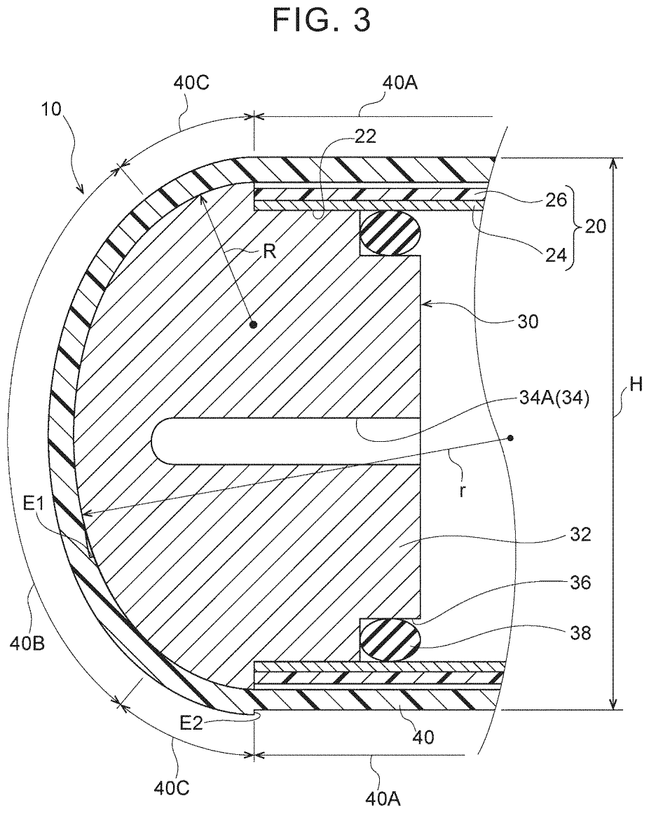

As shown in FIGS. 2 and 3, the body portion 20 includes, for example, a cylindrical liner 24 and a reinforcing layer 26 provided on the outer peripheral surface of the liner 24. The liner 24 is made of an aluminum alloy, and the reinforcing layer 26 is made of carbon fiber reinforced plastic (CFRP). The reinforcing layer 26 is formed by wrapping a sheet of CFRP impregnated in advance with resin around the outer peripheral surface of the liner 24 or by wrapping carbon fibers around the outer peripheral surface of the liner 24 and then impregnating the carbon fibers with resin. On the inner peripheral surface side of the reinforcing layer 26, the carbon fibers, not shown, in the CFRP are arranged in the circumferential direction of the liner 24 and the body portion 20.

The boss 30 has a generally semi-cylindrical shape having an axial outer portion being curved outward in the axial direction. The boss 30 has an insertion portion 32 and a communication flow path 34. The insertion portion 32 is a portion that is inserted into an opening 22 of the high-pressure tank 10. The insertion portion 32 has a generally cylindrical shape protruding inward in the axial direction. The outer peripheral surface of the insertion portion 32 is in contact with the inner peripheral surface of the body portion 20. A gasket accommodating portion 36 is formed around the tip end of the insertion portion 32. The gasket accommodating portion 36 is formed by cutting out the outer edge of the insertion portion 32. An O-ring 38 is accommodated in the gasket accommodating portion 36. The O-ring 38 is elastically deformed in the radial direction. The body portion 20 is closed at its one axial end and the other axial end by the insertion portions 32 of the bosses 30.

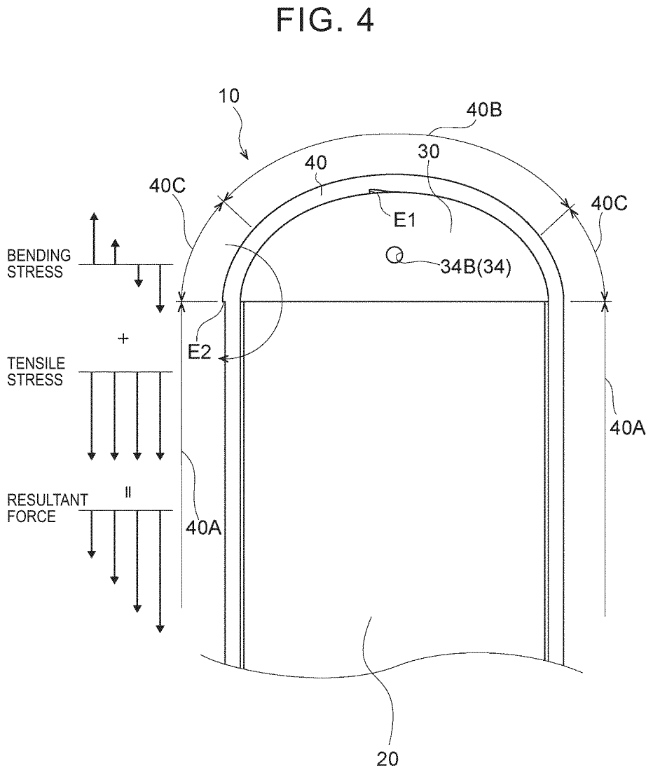

The communication flow path 34 is formed inside the boss 30. The communication flow path 34 includes a first communication flow path 34A and a second communication flow path 34B (see FIG. 4). The first communication flow path 34A extends in the axial direction in the insertion portion 32 and is open to the inside of the body portion 20 in the axial direction. The second communication flow path 34B extends in the width direction of the body portion 20 and is connected to the first communication flow path 34A. The second communication flow paths 34B of adjacent ones of the high-pressure tanks 10 are connected together such that the body portions 20 of the plurality of high-pressure tanks 10 communicate with each other. The plurality of body portions 20 may be connected to a boss having a plurality of insertion portions 32.

A valve, not shown, which is a valve member, is placed in the communication flow path 34 in the boss 30. With this valve, the amount of fluid flowing in the communication flow path 34 can be controlled. The communication flow paths 34 in the bosses 30 are connected to a fuel cell stack, a supply pipe, etc., which are not shown.

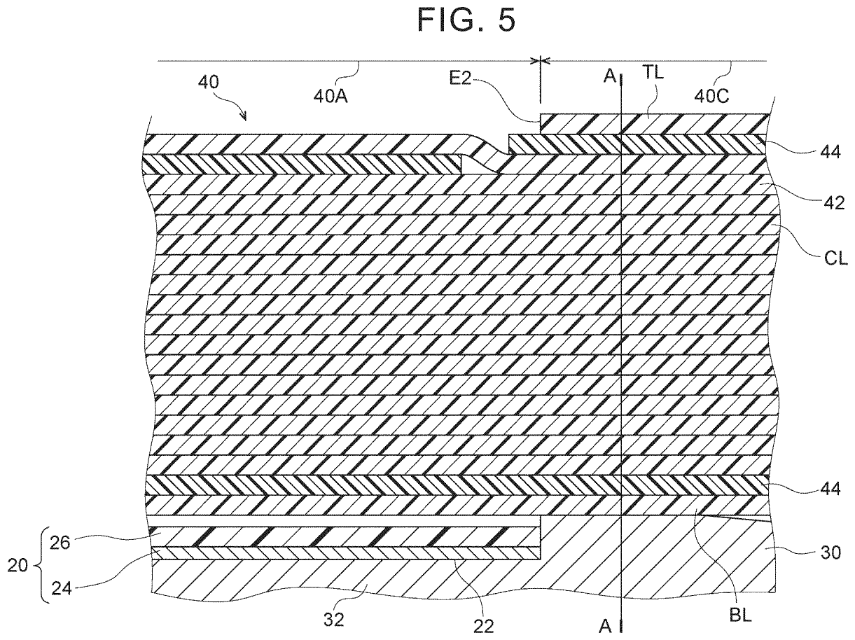

The fixing belt 40 is provided outside the body portion 20 in the radial direction and outside the pair of bosses 30. Specifically, the fixing belt 40 is wrapped around the outer side surfaces of the pair of bosses 30 so as to extend in the axial direction. The fixing belt 40 has a wrap belt 42 wrapped around the body portion 20 in the axial direction and an interlayer belt 44 provided between layers of the wrap belt 42. As shown in FIG. 5, the fixing belt 40 is wrapped around the body portion 20 in 20 layers along line A-A. The second and eighteenth layers from the inside in the radial direction are the interlayer belt 44, and the other layers are the wrap belt 42.

As shown in FIG. 3, the fixing belt 40 includes a pair of straight portions 40A, a pair of outer peripheral portions 40B, and curved portions 40C. The straight portions 40A extend along the body portion 20 in the axial direction. The outer peripheral portions 40B extend along the outer side surfaces of the bosses 30 which are located on the outer side in the axial direction of the body portion 20. Each curved portion 40C connects the straight portion 40A and the outer peripheral portion 40B. The outer peripheral portions 40B and the curved portions 40C are an example of a curved portion. The high-pressure tank 10 is formed so as to satisfy R>H/3, where R represents the radius of the curved portion 40C and H represents the height of the high-pressure tank 10. The high-pressure tank 10 is also formed so as to satisfy r>H/2, where r represents the radius of the outer peripheral portion 40B.

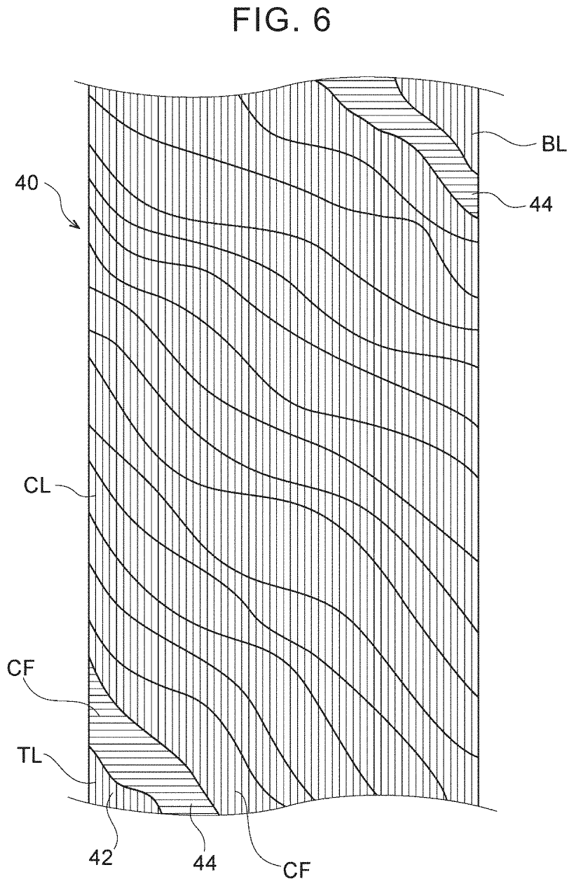

As shown in FIG. 6, the wrap belt 42, which is a first CFRP belt, is a belt made of CFRP and is a unidirectional (UD) tape having carbon fibers CF that extend in the 0° direction along the axial direction. The 0° direction along the axial direction includes an error in the direction of the carbon fibers CF which occurs when manufacturing the wrap belt 42 and an error in the direction of the carbon fibers CF which occurs when the wrap belt 42 is wrapped around the body portion 20. The wrap belt 42 is what is called a prepreg composed of the carbon fibers CF pre-impregnated with resin and is cured after being wrapped around the body portion 20. With a radially inner end E1 of the wrap belt 42 fixedly bonded to the outer side surface of the boss 30 (see FIG. 3), the wrap belt 42 is wrapped 17 turns around the body portion 20 to form wrap layers CL, and then a radially outer end E2 of the wrap belt 42 is fixedly bonded to the interlayer belt 44 near the connection portion between the straight portion 40A and the curved portion 40C (see FIG. 5).

As shown in FIG. 6, the interlayer belt 44 is a belt made of CFRP and is a UD tape having carbon fibers CF that extend in the 90° direction along the axial direction of the body portion 20. The 90° direction along the axial direction includes an error in the direction of the carbon fibers CF which occurs when manufacturing the interlayer belt 44 and a variation in the direction of the carbon fibers CF which occurs when the interlayer belt 44 is wrapped around the body portion 20. The interlayer belt 44 is what is called a prepreg composed of the carbon fibers CF pre-impregnated with resin and is cured after being wrapped around the body portion 20. In the present embodiment, the proportion of the carbon fibers CF of the interlayer belt 44 in the entire fixing belt 40 is 10%.

As shown in FIG. 5, the interlayer belt 44, which is a second CFRP belt, is stacked adjacent to the wrap belt 42 in a top layer TL that is the outermost layer. Specifically, the interlayer belt 44 is wrapped one turn between the wrap belt 42 in the top layer TL of the fixing belt 40 and the wrap belt 42 that is one turn before the top layer TL.

The interlayer belt 44, which is a third CFRP belt, is stacked adjacent to the wrap belt 42 in a bottom layer BL. Specifically, the interlayer belt 44 is wrapped one turn between the wrap belt 42 in the bottom layer BL of the fixing belt 40 and the wrap belt 42 that is one turn after the bottom layer BL.

### Manufacturing Method

The high-pressure tank 10 is manufactured as follows. First, the worker prepares the bosses 30 with the O-ring 38 accommodated in advance in the gasket accommodating portion 36. Next, the worker inserts the insertion portions 32 of the bosses 30 into the openings 22 of the body portion 20 to attach the bosses 30 to respective axial ends of the body portion 20.

The worker then brings the end E1 of the wrap belt 42 into contact with the outer peripheral surface of the boss 30 and wraps the wrap belt 42 about one turn around the body portion 20 in the axial direction. After the resin is cured, the end E1 of the wrap belt 42 is bonded to the boss 30. The worker wraps the interlayer belt 44 one turn around the wrap belt 42 in the first layer and then cuts the interlayer belt 44. It is desirable that the starting point (end) and the end point (end) of the interlayer belt 44 that is to be the second layer be located at positions other than on the curved portions 40C.

The worker then wraps the wrap belt 42 about 16 turns around the interlayer belt 44, namely until the 18th layer is formed. The worker wraps the interlayer belt 44 one turn around the wrap belt 42 in the 17th layer and then cuts the interlayer belt 44. It is desirable that the starting point (end) and the end point (end) of the interlayer belt 44 that is to be the 18th to 19th layer be located on the straight portion 40A.

The worker further wraps the wrap belt 42 about one turn around the interlayer belt 44, namely until the 20th layer is formed. The worker wraps the wrap belt 42 that is to be the 20th layer from the outer peripheral portion 40B to the straight portion 40A via the curved portion 40C. The worker then cuts off the excess wrap belt 42 such that the end E2 of the wrap belt 42 is located near the connection portion between the straight portion 40A and the curved portion 40C.

The resin impregnated in the wrap belt 42 and the interlayer belt 44 is cured. The high-pressure tank 10 is thus completed. It is herein assumed that the worker performs the above process. However, the disclosure is not limited to this, and the process may be mechanized by a manufacturing apparatus.

### Functions and Effects

Functions and effects of the embodiment will be described.

In the high-pressure tank 10 of the present embodiment, when the internal pressure is increased by the fluid contained in the high-pressure tank 10, the bosses 30 are pressed outward in the axial direction, and tension is applied to the fixing belt 40. A compressive force in the thickness direction of the fixing belt 40, that is, a surface pressure, is applied to portions of the fixing belt 40 which are in contact with the bosses 30.

In the high-pressure tank 10, as the radius r of the outer peripheral portion 40B increases, that is, as the radius of the outer periphery of the boss 30 increases, the axial length of the high-pressure tank 10 becomes shorter. However the angle at which the straight portion 40A is connected to the outer peripheral portion 40B becomes closer to the right angle. As the radius R of the curved portion 40C that is the connection portion between the straight portion 40A and the outer peripheral portion 40B becomes smaller, the surface pressure that is applied to the fixing belt 40 increases. In the present embodiment, P∝F/R is satisfied (P is proportional to F/R), where P is the surface pressure applied to the fixing belt 40, and F is the tension applied to the fixing belt 40. That is, as the tension F increases and the radius R becomes smaller, the surface pressure applied to the fixing belt 40 increases.

The high-pressure tank 10 of the present embodiment is formed such that the curved portions 40C of the fixing belt 40 satisfy R>H/3. This configuration reduces the surface pressure applied to the fixing belt 40 in the thickness direction thereof and reduces occurrence of a compression failure. The radius R of the curved portion 40C need not necessarily be uniform. The radius R of the curved portion 40C may be gradually changed to be larger as closer to the R end (the end of the curve, and the connection portion between the straight portion 40A and the curved portion 40C) which includes a bent and to which a large tensile stress is applied. This configuration further improves the strength of the fixing belt 40 against compression.

In the present embodiment, the proportion of the carbon fibers CF of the 90° direction in the entire fixing belt 40 is 10%. It is difficult for the wrap belt 42 having the carbon fibers CF in the 0° direction with respect to the axial direction to have sufficient strength in the thickness direction when the tension acts in the 0° direction. For the UD tapes that configure the fixing belt 40, the performance of the resin more greatly contributes against the force in the 90° direction than the performance of the carbon fibers CF does. Accordingly, the interlayer belt 44 having the carbon fibers CF in the 90° direction with respect to the axial direction is less likely to be affected by the tension in the 0° direction, providing sufficient elasticity in the thickness direction. In the present embodiment, the fixing belt 40 includes a certain proportion of the interlayer belt 44 having the carbon fibers CF in the 90° direction. This provides elasticity in the thickness direction as compared to the case where the entire fixing belt 40 is composed only of the wrap belt 42. According to the present embodiment, the fixing belt 40 has sufficient strength in the tensile direction in the curved portions 40C where the surface pressure is larger, and occurrence of the compression failure is suppressed.

In order to reduce the influence of the compressive force (surface pressure) that is applied from the bosses 30 to the curved portions 40C of the fixing belt 40, it is desirable that the interlayer belt 44 be located in a layer as close to the bottom layer as possible, specifically in the second layer.

In the fixing belt 40 of the present embodiment, the interlayer belt 44 is stacked adjacent to the top layer TL near the end E2 that is the wrapping end of the wrap belt 42. A stress is uniformly applied to both sides of the wrap belt 42 in the axial direction in the lower layers where the end E2 is not disposed. At the end E2 of the wrap belt 42, however, a stress is intensively applied between the layers on the side where wrapping of the wrap belt 42 is ended. Accordingly, in the case where there is no interlayer belt 44 and only the wrap belt 42 is wrapped around the body portion 20, a shear stress is intensively applied at the end E2. In this case, the layers may be separated from each other.

In the present embodiment, the end E2 of the wrap belt 42 is bonded to the interlayer belt 44. For the UD tapes that configure the fixing belt 40, the performance of the carbon fibers CF greatly contributes against the force in the 0° direction and the performance of the resin greatly contributes against the force in the 90° direction. That is, the CFRP having the carbon fibers CF in the 0° direction has sufficient tensile strength in the 0° direction, and the CFRP having the carbon fibers in the 90° direction provides sufficient elasticity in the 0° direction. As in the present embodiment, the interlayer belt 44 having the carbon fibers CF in a direction perpendicular to the direction of the tension provides elasticity in the axial direction. According to the present embodiment, even when a shear stress is intensively applied to the end E2 of the wrap belt 42, this shear stress is reduced by the elasticity of the interlayer belt 44. The separation of the layers of the fixing belt 40 from each other is therefore suppressed.

In the present embodiment, the end E2 of the wrap belt 42 is located near the connection portion between the straight portion 40A and the curved portion 40C. As shown in FIG. 4, in the fixing belt 40, both a bending stress and a tensile stress are applied at the end of the curve where the curved portion 40C is changed to the straight portion 40A. The bending stress that is applied to the end of the curve is a stress that acts outward in the axial direction on the upper layer side of the wrap belt 42 and that acts inward in the axial direction on the lower layer side of the wrap belt 42. Accordingly, in the resultant force of the bending stress and the tensile stress, the tensile stress is cancelled by the bending stress on the upper layer side of the wrap belt 42. That is, the tensile stress applied to the end of the curve, namely to the connection portion between the straight portion 40A and the curved portion 40C, is reduced as closer to the top layer of the wrap belt 42. Since the end E2 of the wrap belt 42 is located near the end of the curve, the separation of the layers of the fixing belt 40 from each other is further suppressed.

### Second Embodiment

A second embodiment is an example in which a restraining structure for a structural object is applied to a battery unit 50. In the second embodiment, the same configurations as those of the first embodiment are denoted by the same reference signs as those of the first embodiment, and description thereof will be omitted.

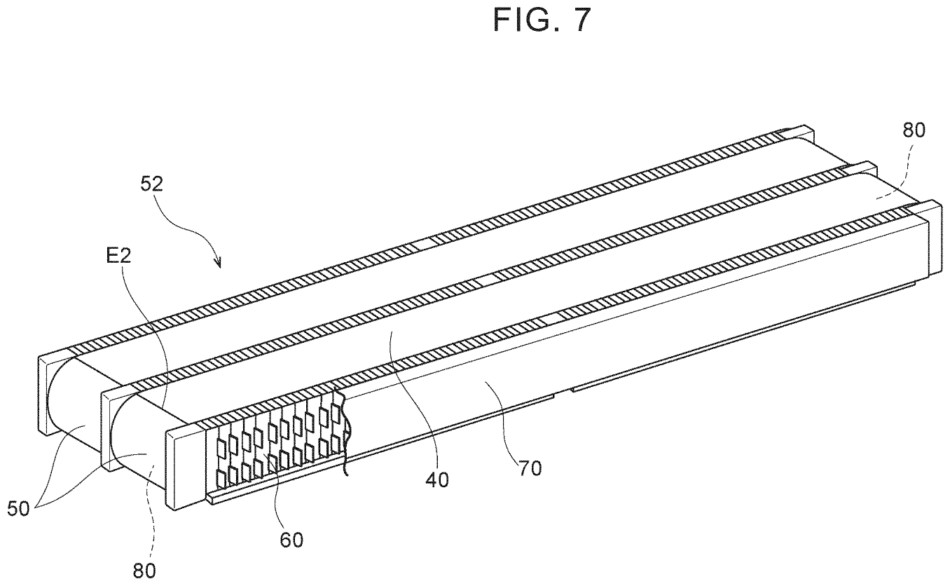

As shown in FIG. 7, the battery unit 50, which is a structural object, forms a part of a battery module 52. That is, the battery module 52 is configured by arranging and connecting a plurality of battery units 50. For example, the battery module 52 is accommodated under a floor panel of an electric vehicle. The battery unit 50 of the present embodiment is an example of the all-solid-state battery.

The battery unit 50 has the shape of a prism, and a plurality of cells 60 of the battery unit 50 are stacked in the longitudinal direction of the vehicle. In the present embodiment, the stacking direction of the cells 60 and the longitudinal direction of a tubular case 70 are the axial direction, and a direction perpendicular to the stacking direction of the cells 60 is the radial direction. The battery unit 50 includes the cells 60, the tubular case 70, a pair of fixing portions 80, and the fixing belt 40. The cells 60 are arranged side by side in the axial direction. The tubular case 70 covers the cells 60. The fixing portions 80 are provided at respective axial ends of the case 70. The fixing belt 40 is wrapped around the case 70 so as to extend between the fixing portions 80 in the axial direction of the case 70. The cells 60 are an example of the restrained portion that is the stacked body, and the fixing portions 80 are an example of the holding portions.

The cells 60 are stacked in the axial direction, and adjacent ones of the cells 60 are connected in series. The cells 60 are interposed between the fixing portions 80 in the axial direction. The case 70 is a rectangular tubular member that covers the stacked cells 60 from outside in the radial direction.

In the present embodiment, the fixing belt 40 restrains the stacked cells 60 in the axial direction. Accordingly, when the cells 60 expand during charge and discharge cycles, an axial tension F is applied to the fixing belt 40. The present embodiment thus has functions and effects similar to those of the first embodiment.

### Remarks

In each of the embodiments, the angle of the carbon fibers CF in the interlayer belt 44 need not necessarily be 90°. The angle of the carbon fibers CF in the interlayer belt 44 with respect to the axial direction may any angle that is 45° or more and 90° or less. The angle of the carbon fibers CF in the interlayer belt 44 may vary between the interlayer belt 44 in the lower layer and the interlayer belt 44 in the upper layer.

In each of the embodiments, the proportion of the carbon fibers CF of the 90° direction in the entire fixing belt 40 is 10%. However, the disclosure is not limited to this. The fixing belt 40 need only be configured such that the proportion of the carbon fibers CF in the 45° to 90° directions to the carbon fibers CF in the entire fixing belt 40 is 10% or more and 50% or less.

In each of the embodiments, the end E1 of the wrap belt 42 is bonded to the outer peripheral surface of the boss 30. However, the disclosure is not limited to this. The end E1 of the wrap belt 42 may be bonded to the body portion 20 or the fixing belt 40. In the case where the end E1 of the wrap belt 42 is bonded to the fixing belt 40, the end E1 is fixedly bonded to the interlayer belt 44 located adjacent to the end E1, similar to the end E2. With this configuration, even when a shear stress is intensively applied to the end E1, this shear stress is reduced by the elasticity of the interlayer belt 44. The separation of the layers of the fixing belt 40 from each other is therefore suppressed.

Although the embodiments of the disclosure are described above, the disclosure is not limited to the above, and various modifications in addition to those described above can be made without departing from the spirit and scope of the disclosure.

What is claimed is:

1. A restraining structure for a structural object, comprising:
a restrained portion that is a tubular body or a stacked body;
a pair of holding portions provided at the restrained portion, one of the holding portions being provided at an end of the restrained portion, the other of the holding portions being provided at the other end of the restrained portion;
a first CFRP belt wrapped around the restrained portion in an axial direction of the restrained portion so as to extend between the pair of holding portions and having carbon fibers of a 0° direction along the axial direction; and
a second CFRP belt stacked adjacent to an outermost layer near an end of the first CFRP belt and having carbon fibers of 45° to 90° directions with respect to the axial direction.

2. The restraining structure for the structural object according to claim 1, wherein
the end of the first CFRP belt is disposed near a connection portion between a curved portion of the first CFRP belt and a straight portion of the first CFRP belt that extends along the restrained portion.

3. The restraining structure for the structural object according to claim 1, further comprising a third CFRP belt having the carbon fibers of the 45° to 90° directions with respect to the axial direction, wherein
the third CFRP belt is stackable between layers of the first CI-RP belt wrapped around the restrained portion, and
a proportion of the carbon fibers of the 45° to 90° directions in all stacked belts is 10% or more and 50% or less.
